(19) United States
(12) Patent Application Publication
(10) Pub. No.: US 2008/0195652 A1
(43) Pub. Date: Aug. 14, 2008

(54) USER INTERFACE FORMING METHOD AND APPARATUS BASED ON HUMAN RELATIONS FOR MOBILE TERMINAL

(75) Inventors: Tae Won Um, Seoul (KR); Seung Woo Shin, Seoul (KR); Hyun Kyung Shin, Seoul (KR); Bong Hee Kim, Cheonan-si (KR); Jung Hun Kim, Busan Metropolitan City (KR)

Correspondence Address: Jefferson IP Law, LLP, 1730 M Street, NW, Suite 807, Washington, DC, 20036, US

(73) Assignee: Samsung Electronics Co. Ltd., Suwon-si (KR)

(21) Appl. No.: 12/027,162

(22) Filed: Feb. 6, 2008

(30) Foreign Application Priority Data
Feb. 8, 2007 (KR) 10-2007-0013403

(51) Int. Cl. G06F 17/30

(52) U.S. Cl. 707/102; 707/E17.005

(57) ABSTRACT

An apparatus and method for forming a user interface for a mobile terminal based on human relations are provided. The method includes creating a piece of log data corresponding to a communication event, calculating a level of intimacy between the user and a counterpart for a target duration using the log data and displaying human relations of the user on the basis of the intimacy level. A user item representing the user and a counterpart item representing the counterpart are displayed in a human relations network screen. Lower-level screens are allocated to provide summary and detailed information on the log data and to enable communication. A new user interface, which is based not on functions but on human relations, enables the user to readily identify a trend in human relations and levels of communication with other persons.

### PRIORITY

This application claims the benefit under 35 U.S.C. §119(a) of a Korean patent application filed in the Korean Intellectual Property Office on Feb. 8, 2007 and assigned Serial No. 2007-0013403, the entire disclosure of which is hereby incorporated by reference.

### BACKGROUND OF THE INVENTION

1. Field of the Invention

The present invention relates generally to a user interface for a mobile terminal. More particularly, the present invention relates to a method and an apparatus of forming a user interface for a mobile terminal, wherein levels of intimacy with other persons are calculated using log data of the mobile terminal and human relations of the user are represented.

2. Description of the Related Art

With advances in information processing and communication technologies as well as advances in semiconductor technologies, the popularity of mobile terminals has grown over the years. Mobile terminals are now considered an indispensable item and have gained worldwide popularity. In addition to providing conventional voice calls and text messaging services, mobile terminals now support various advanced functions. Examples of these advanced functions include the downloading and reproduction of multimedia files, access and use of wireless Internet, wireless short-range communication and digital broadcast reception. Furthermore, usability factors such as size, design, resolution and user interface have also greatly improved.

A mobile terminal maintains logs of events such as a log of calls and messages made or received. The mobile terminal maintains such a log for a limited time duration. Normally, recent calls are recorded in a call log and recent messages are recorded in a message log. That is, communication events are divided according to their types and separately listed in a chronological order, starting from the most recent event. These separately maintained logs facilitate personal communication by types of recent events.

However, the use of separately maintained event logs makes it difficult to identify certain human relations of the user and levels of communication with individual persons. For example, a person who recently placed or received a call to or from the user or who recently sent or received a message to or from the user can be readily identified. On the other hand, it is difficult to identify an overall trend in human relations of the user. For example, it is not easy to find a person who the user has been or has not been in frequent communication with for a particular time duration.

### SUMMARY OF THE INVENTION

An aspect of the present invention is to address at least the above-mentioned problems and/or disadvantages and to provide at least the advantages described below. Accordingly, an aspect of the present invention is to provide a new user interface for a mobile terminal that is based on human relations.

Another aspect of the present invention is to provide a method of representing human relations of the user and levels of communication with individual persons in a mobile terminal.

Yet another aspect of the present invention is to provide a means for more intuitive and useful access to log data through a user interface based on human relations.

In accordance with an aspect of the present invention, a user interface forming method based on human relations for a mobile terminal is provided. The method includes creating, in response to occurrence of a communication event between a user and a counterpart, a piece of log data corresponding to the communication event, adding the created piece of log data to existing log data, calculating levels of intimacy between the user and counterparts for a target duration using the log data and displaying human relations of the user on the basis of the calculated intimacy levels.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates an example of a human relations network screen according to an exemplary embodiment of the present invention;

FIG. 2 illustrates another example of a human relations network screen according to an exemplary embodiment of the present invention;

FIG. 3 illustrates another example of a human relations network screen according to an exemplary embodiment of the present invention;

FIGS. 4A to 4E illustrate lower-level screens of the human relations network screen related to the user according to an exemplary embodiment of the present invention.

FIGS. 5A to 5D illustrate lower-level screens of the human relations network screen related to other persons according to an exemplary embodiment of the present invention;

FIG. 6 is a schematic block diagram illustrating a mobile terminal according to an exemplary embodiment of the present invention;

FIG. 7 is a flowchart illustrating a first part of a user interface forming method based on human relations according to another exemplary embodiment of the present invention;

FIG. 8 is a flowchart illustrating an exemplary step of calculating levels of intimacy in the flowchart of FIG. 7;

FIG. 9 is a flowchart illustrating an exemplary step of displaying human relations in the flowchart of FIG. 7; and

FIG. 10 is a flowchart illustrating an exemplary second part of the user interface forming method of FIG. 7.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention relates to a user interface for a mobile terminal, wherein levels of intimacy with other persons are calculated using log data of the mobile terminal and human relations of the user are represented.

In a user interface forming method according to an exemplary embodiment of the present invention, in response to occurrence of a communication event between the user and another person, log data is updated to accommodate the communication event, levels of intimacy between the user and other persons for a target duration are calculated and human relations are represented on the basis of the calculated intimacy levels.

In the following exemplary embodiments of the invention, the term “log data” means a record of communication events that have occurred in a mobile terminal, such as a log of calls that have been placed or received, a log of messages that have been sent or received, a log of instant messages that have been sent or received, a log of data that has been sent or received and the like. The term “communication” means a telephone call, the sending or receiving of a message, an instant message, or data communication and the like. The log data can include occurrence dates and times of communication events, counterparts of communication and details of communication. The details of communication can include quantitative parameters such as dialog durations and amounts of data, and frequency parameters such as the number of calls, messages, instant messages, data transfers and the like.

The term “intimacy” is a measure of communication between the user and a counterpart. The level of intimacy is calculated for each counterpart. The level of intimacy between the user and a counterpart is calculated from log data for a target duration with respect to particular communication means. The level of intimacy can be the sum of quantitative parameter values related to individual communication means, the sum of frequency parameter values, or two sums of quantitative and frequency parameter values. Weights can be assigned to individual communication means. In an exemplary embodiment, after calculation of intimacy levels for all counterparts, a number of counterparts are selected based on the highest intimacy levels and a list of the selected counterparts are displayed on the screen.

In the following description, a human relations network screen denotes a screen displaying a list of counterparts according to their levels of intimacy with the user. A user item denoting the user and counterpart items denoting communication counterparts of the user are displayed on the human relations network screen. The user and counterpart items can be represented using human images, icons, emotional metaphors and the like. The locations, arrangement orders, sizes, colors and shapes of counterpart items can be determined according to intimacy levels associated with the counterpart items. Those counterpart items belonging to the same group in a phonebook can be arranged closely to each other. The user item can be connected to a counterpart item through a line segment, whose length is in inverse proportion to the level of intimacy between the user and the counterpart denoted by die counterpart item.

In an exemplary implementation, the user item and counterpart items are respectively associated with lower-level screens. Lower-level screens can include log screens and activity screens. When the user item is selected, an overall log screen is displayed. The overall log screen provides summary information on entire log data, and can also provide summary information on contents created by the user. Selection of a counterpart item leads to display of a log screen associated with the counterpart item, which provides summary information on log data related to the corresponding counterpart. A screen transition input in a log screen leads to display of an activity screen to support a communication-related activity. In the human relations network screen, selection of a line segment leads to display of a log screen associated with a counterpart item linked to the selected line segment, and selection of the counterpart item can lead to display of an activity screen. When a communication means is selected in the overall log screen or in a log screen associated with a particular counterpart, a detail screen associated with the selected communication means is displayed. The detail screen provides detailed information on log data related to the selected communication means.

An exemplary user interface of the present invention includes a “human relations network screen” created on the basis of levels of intimacy with other persons and its lower-level screens.

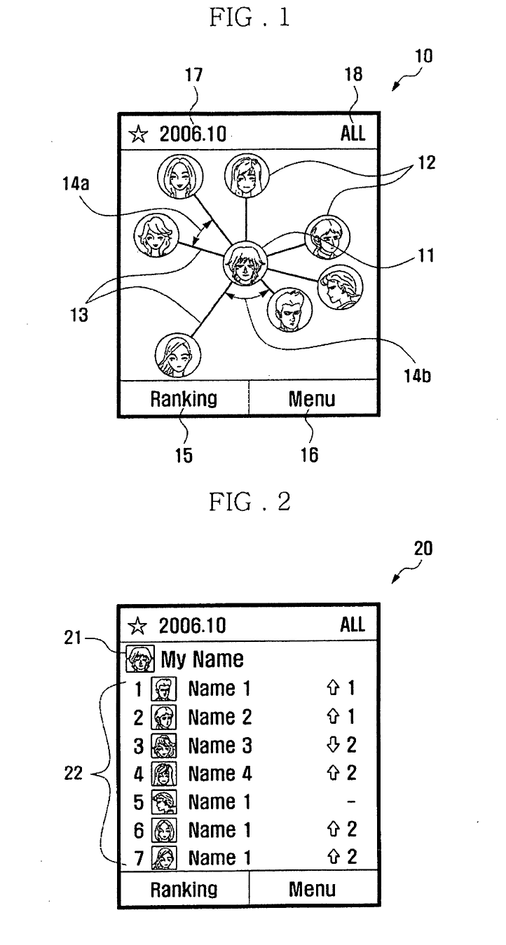

FIG. 1 illustrates an example of a human relations network screen according to an exemplary embodiment of the present invention. In FIG. 1, the human relations network screen 10 is a main screen that represents human relations of the user based on intimacy levels derived from log data. A user item 11, denoting the user, is located at the center of the human relations network screen 10. Counterpart items 12, denoting communication counterparts of the user, are arranged around the user item 11.

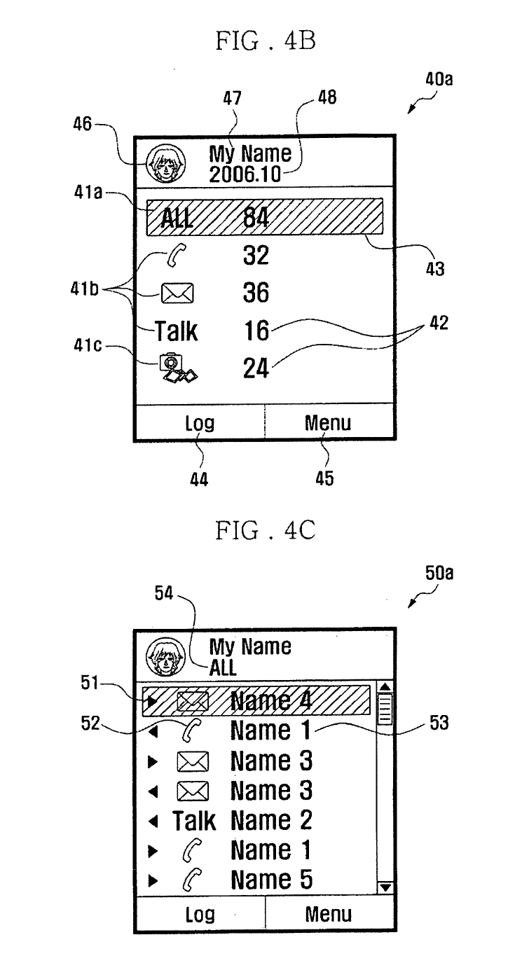

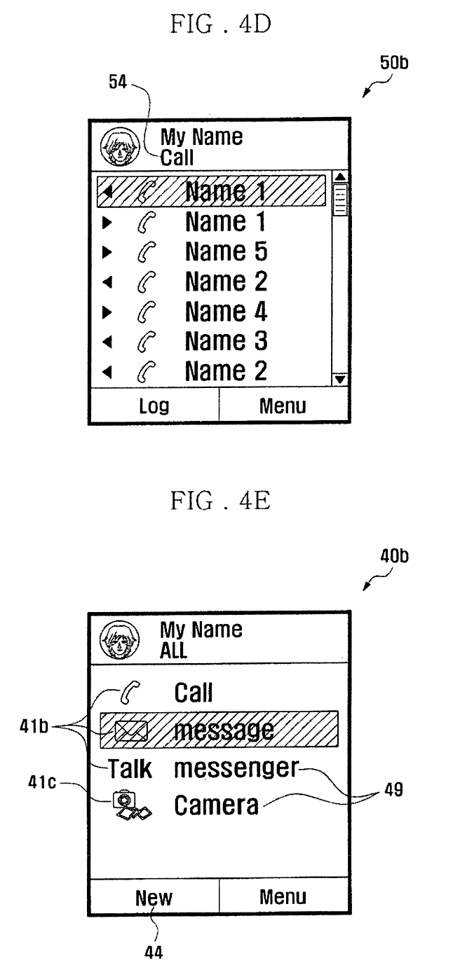

The user item 11 represents the user. In an exemplary implementation, selection of the user item 11 can lead to lower-level screens. The lower-level screens provide a record of communication events, enable search of contents created by the user and enable creation of new contents Examples of lower-level screens are described later in connection with FIGS. 4A to 4E. A face image of the user, for example an image of the user taken by a camera of the mobile terminal or an image downloaded onto the mobile terminal, or a pre-stored icon can be used as the user item 11. The image or icon used as the user item 11 can be replaced using a ‘Menu’ key 16 at the lower right end of the human relations network screen 10.

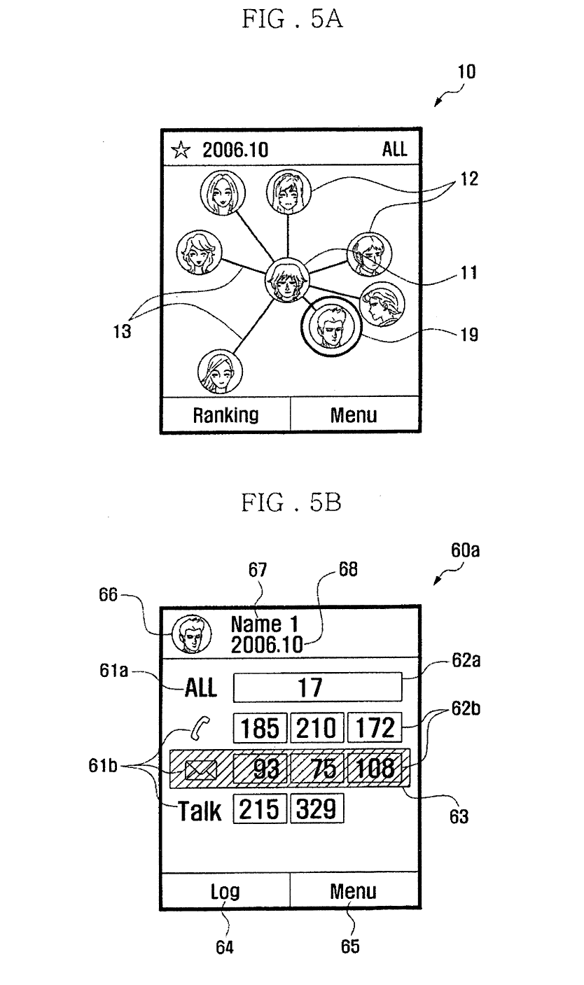

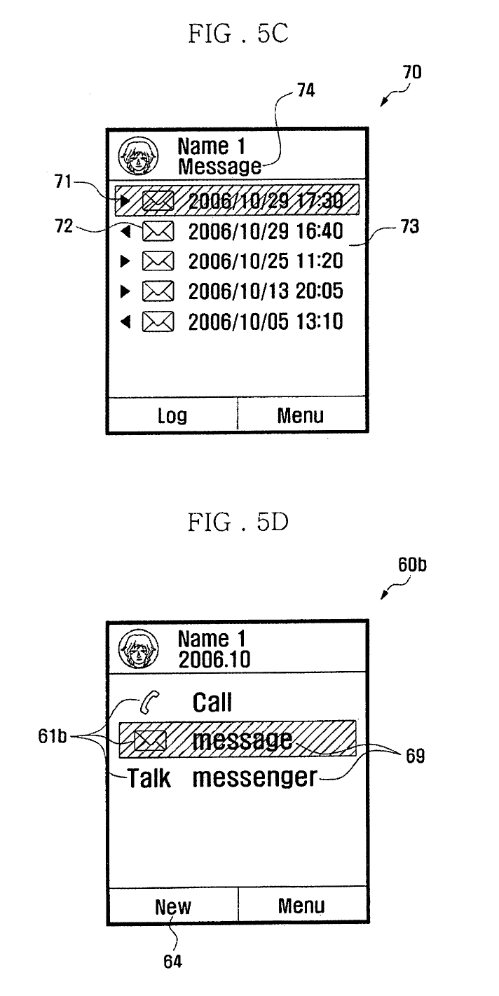

A counterpart item 12 represents a counterpart that may be in communication with the user. A preset number of counterpart items 12, associated with counterparts having the highest intimacy levels, are displayed. The number of displayed counterpart items 12 can be varied depending upon restrictions of the human relations network screen 10. For example, all counterparts may be represented on the screen. Alternatively, a restricted number of counterpart items 12 associated with those counterparts selected by the user can also be displayed. At the lower left end of the human relations network screen 10, soft key 15, which functions as a scope indicator, can be used to determine which counterparts are represented on the screen. In the illustrated example of FIG. 1, the label ‘Ranking’ indicates all counterparts are represented on the screen. In another example, not illustrated, a label ‘Favorites’ is displayed on the key 15 which indicates that a restricted number of counterparts are represented. The ‘Ranking’ mode and ‘Favorites’ mode can be switched to each other through the left soft key 15. A face image of a counterpart or pre-stored icon can be used as a corresponding counterpart item 12. Similar to the user item, an image of the counterpart taken by the camera of the mobile terminal or an image downloaded onto the mobile terminal may be used as the counterpart item 12. An image or icon used as a counterpart item 12 can be replaced through the ‘Menu’ key. Selection of a counterpart item 12 can lead to a lower-level screen providing a record of communication events related to the corresponding counterpart. Exemplary use of counterpart items 12 is described later in connection with FIGS. 5A to 5D.

The user item 11 and a counterpart item 12 are connected with a line segment 13. The length of the line segment 13 denotes the level of intimacy between the user and a corresponding counterpart. For example, a short line segment 13 indicates a high intimacy level. Calculation of intimacy levels is described in detail below.

Counterpart items 12 are arranged in clusters. That is, those counterpart items 12 belonging to the same group in the phonebook are arranged closely to each other. In addition, the angle 14a formed by the user item 11 and two counterpart items 12 belonging to the same group is set to be less than the angle 14b formed by the user item 11 and two counterpart items 12 not belonging to the same group.

A duration indicator 17 is displayed at the upper left end of the human relations network screen 10. The duration indicator 17 indicates a time duration corresponding to a portion of the log data that is analyzed for intimacy level calculation. The time duration can be specified in a form relative to the current date (for example, the more recent month or the most recent three months), or specified in a definite form (for example, October 2006). The human relations network screen 10 of FIG. 1 represents human relations of the user as of October in 2006. The time duration can be set by the user to view human relations in the past. Setting of the time duration can be made through the ‘Menu’ key 16, or through direct selection of the duration indicator 17.

A means indicator 18 is displayed at the upper right end of the human relations network screen 10. The means indicator 18 indicates one or more communication means used to calculate intimacy levels. As previously described, the communication means include telephone calls, messages, instant messages, and data communications. Some or all of the communication means can be used to calculate intimacy levels. The means indicator 18 having a label ‘ALL’ in FIG. 1 indicates that all the communication means are used to calculate intimacy levels. The user can set the communication means to be used, and can identify human relations for each communication means. Setting of the communication means to be used can be made through the ‘Menu’ key 16, or through direct selection of the means indicator 18.

Levels of intimacy for human relations are derived from the log data. Hereinafter, derivation of intimacy levels from the log data is described using an example.

It is assumed that levels of intimacy are derived using log data for a duration of October in 2006 and communication means of telephone calls and messages. A piece of log data is created in response to an occurrence of a communication event and added to the existing log data. Table 1 illustrates a portion of log data for the duration.

TABLE 1

| | | Counterpart | | Details | |
|---|---|---|---|---|---|
| Event | Date & Time | Name | Phone number | Length | Data |
| Call r | 10/1/2006 9:00 | Name 1 | 010-111-2222 | 185 | |
| Message s | 10/2/2006 15:30 | Name 2 | 010-333-4444 | | 80 |
| Message r | 10/2/2006 16:00 | Name 2 | 010-333-4444 | | 45 |
| Call s | 10/2/2006 16:10 | Name 2 | 010-333-4444 | 90 | |
| Call s | 10/3/2006 10:30 | Name 3 | 010-555-6666 | 125 | |
| Call r | 10/3/2006 12:00 | Name 4 | 010-777-8888 | 105 | |
| Call r | 10/3/2006 17:30 | Name 5 | 010-999-0000 | 275 | |
| . . . | . . . | . . . | . . . | . . . | . . . |
| Message r | 10/30/2006 21:30 | Name 6 | 010-123-4567 | | 65 |
| Call r | 10/30/2006 22:00 | Name 4 | 010-777-8888 | 130 | |

(r for receive, s for send, length in seconds, data in bytes)

Levels of intimacy with communication counterparts are calculated using the log data. Table 2 illustrates statistics derived from the log data of Table 1.

TABLE 2

| Counterpart | Calling time | | Calls | Data amount | Messages |
|---|---|---|---|---|---|
| Name 1 | 585 | seconds | 3 | 0 bytes | 0 |
| Name 2 | 1250 | seconds | 10 | 750 bytes | 12 |
| Name 3 | 900 | seconds | 6 | 320 bytes | 5 |
| Name 4 | 1450 | seconds | 11 | 0 bytes | 0 |
| Name 5 | 2130 | seconds | 7 | 110 bytes | 3 |
| Name 6 | 0 | seconds | 0 | 140 bytes | 2 |

The intimacy level of a counterpart can be calculated in various manners or algorithms. That is, the formula and weights for intimacy level calculation can be set in advance and changed by the user. The following are examples of algorithms used to determine the intimacy level:

intimacy level=A1×accumulated-calling-time+A2×total-amount-of-data(A1,A2: weights) (1)

intimacy level=B1×number-of-calls+B2×number-of-messages(B1,B2: weights) (2)

intimacy level=C1×accumulated-calling-time+C2×number-of-calls+C3×total-amount-of-data+C4×number-of-messages(C1,C2,C3,C4: weights) (3)

Table 3 illustrates levels of intimacy calculated using the first formula (weights: A1=1, A2=0.5).

TABLE 3

| Counterpart | Intimacy level | Line length | Ranking | Favorite |
|---|---|---|---|---|
| Name 1 | 585 | 20.0 mm | 5 | — |
| Name 2 | 1625 | 7.2 mm | 2 | 2 |
| Name 3 | 1060 | 11.0 mm | 4 | 3 |
| Name 4 | 1450 | 8.1 mm | 3 | — |
| Name 5 | 2185 | 5.4 mm | 1 | 1 |
| Name 6 | 70 | — | 6 | — |

Referring to Table 3, the length of a line segment is in inverse proportion to the level of intimacy. That is, line segments become shorter with increasing intimacy levels. In an exemplary implementation, the length of a line segment can be determined relative to a fixed length (for example, 20.0 mm) of the longest line segment (Name 1 in Table 3) as follows:

line segment length for x=(line segment length for Name 1)×(intimacy level of Name 1)÷(intimacy level of x)

As illustrated in Table 3, whereas all counterparts can be represented in the human relations network screen in the ‘Ranking’ mode, only those counterparts selected by the user can be represented in the ‘Favorite’ mode.

Hereinabove, calculation of intimacy levels using log data of the mobile terminal and formation of a human relations network screen using the calculated intimacy levels are described. The above description is provided only for illustrating the concepts of the present invention and should be considered as an example. The concepts may be modified in various forms. Visualization of the human relations network is not limited to the example illustrated in FIG. 1 and may be represented in a variety of forms. Next, a modified version of the human relations network screen is described.

FIG. 2 illustrates an example of a human relations network screen according to an exemplary embodiment of the present invention. Referring to FIG. 2, items are represented in the form of a list in the human relations network screen 20. That is, a user item 21 and counterpart items 22 are listed in sequence from the top of the human relations network screen 20.

In an exemplary implementation, names can be listed next to the user item 21 and counterpart items 22. The counterpart items 22 are arranged according to their order in corresponding intimacy levels, and the corresponding intimacy orders of each counterpart item can be displayed. Changes in intimacy orders between the previous duration and current duration can also be displayed for the counterpart items 22.

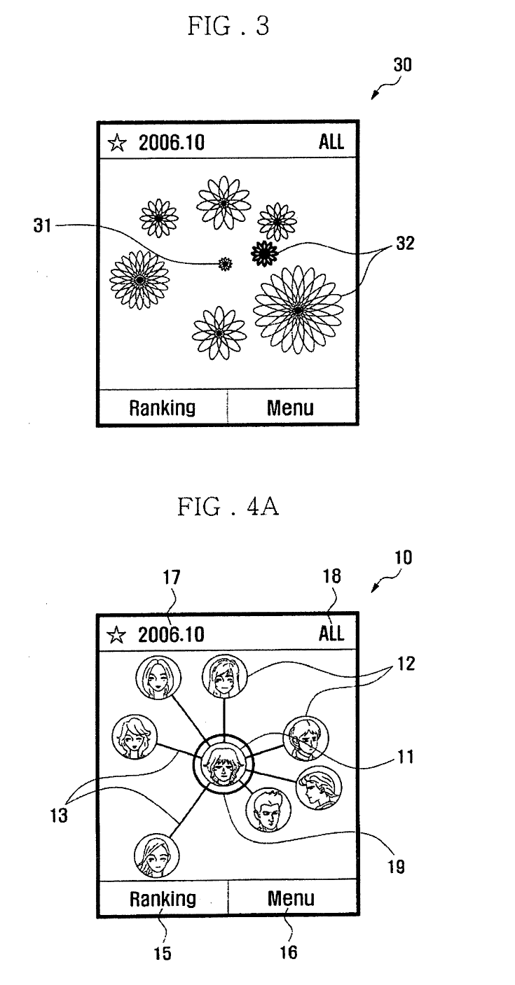

FIG. 3 illustrates another example of a human relations network screen according to an exemplary embodiment of the present invention. Referring to FIG. 3, emotional metaphors are used in a human relations network screen 30. A user item 31 and counterpart items 32 are represented by flowers. Various symbols other than flowers, for example stars, shapes and the like, can be used as emotional metaphors.

The user item 31 represented as a flower is located at the center of the human relations network screen 30, and the counterpart items 32 represented as flowers are arranged around the user item 31. Sizes, locations, colors, and shapes of flowers representing the counterpart items 32 can be determined according to intimacy levels and groupings of the counterpart items 32. For example, with increasing level of intimacy, the flower associated with a particular counterpart item 32 can be set to become greater in size, brighter in color and/or nearer in distance to die user item 31. In addition, flowers associated with those counterpart items 32 belonging to the same group can be set to be similar in color and/or shape. The human relations network screen 30 having emotional metaphors can be used as an idle screen or screen saver for the mobile terminal.

Selection of a user item or counterpart item in the human relations network screen causes an entry into a corresponding lower-level screen. Lower-level screens are described in greater detail below.

FIGS. 4A to 4E illustrate lower-level screens of the human relations network screen related to the user according to an exemplary embodiment of the present invention.

Selection of a user item 11 in a human relations network screen 10 of FIG. 4A leads to the display of a lower-level screen. The selection of the user item 11 may depend upon an input unit of the mobile terminal. If the input unit is a regular keypad, selection of the user item 11 can be made by moving the focus 19 to the user item 11 using a direction key and then pressing the ‘OK’ key. If the input unit is a pointing device such as a touch pad, selection of the user item 11 can be made by moving the pointer to the user item 11. If the input unit is a touch screen, selection of the user item 11 can be made by a direct touch to the user item 11.

Selection of the user item 11 leads to display of a log screen 40a as illustrated in FIG. 4B. The log screen 40a provides a record of communication events and overview information on contents created by the user. For communication events, overview information on all communication means is displayed together with overview information on each communication means.

The log screen 40a includes an icon 41a for all communication means, icons 41b for individual communication means (e.g. telephone calls, messages and instant messages) and an icon 41c for contents (e.g. photographs). Values 42 denoting the number of corresponding communication events or the number of stored contents are displayed next to the icons 41a, 41b and 41c. A focus 43 or pointer (not shown) can be displayed on the log screen 40a. A screen type indicator 44 and a ‘Menu’ key 45 are provided at the lower end of the log screen 40a. The screen type indicator 44 having a label ‘Log’ indicates that the current screen is a log screen. A user item 46, user name 47, and target duration 48 are displayed at the upper end of the log screen 40a.

The log screen 40a of FIG. 4B is only an illustrative example. Log screens can have various compositions. For example, a log screen can be composed similarly to the case of FIG. 5B (described later).

Selecting one of the icon 41a for all communication means, icons 41b for individual communication means, and icon 41c for contents in the log screen 40a using the focus 43 leads to display of a corresponding detail screen. FIG. 4C illustrates a detail screen 50a displayed in response to selection of the icon 41a for all communication means. The detail screen 50a provides a list of communication events in a chronological order. An indicator 51, for indicating whether the communication was outgoing or incoming, an indicator 52, for indicating the communication means and a counterpart name 53 are arranged in the detail screen 50a. A selection indicator 54 is arranged at the upper end of the detail screen 50a. The selection indicator 54 indicates which of ‘all communication means’, ‘individual communication means’, and ‘contents’ options is selected. The selection indicator 54 having a label ‘ALL’ as illustrated in FIG. 4C indicates that the ‘all communication means’ option is selected.

FIG. 4D illustrates a detail screen 50b displayed in response to selection of an icon 41b of the log screen 40a associated with calls as a particular communication means. The detail screen 50b provides a list of calls in a chronological order. The selection indicator 54 has a label ‘Call’.

FIG. 4E illustrates an activity screen 40b. Whereas the log screen 40a of FIG. 4B is used to view a record of communication events and a list of contents, the activity screen 40b is used to perform actions for communication and content creation. The screen type indicator 44 at the lower end of the activity screen 40b has a label ‘New’. A screen transition between the log screen 40a and activity screen 40b can be made by changing the label of the screen type indicator 44 through the left soft key. In the activity screen 40b, an icon 41b and a means name 49 are given to a communication means, and an icon 41c and a type name 49 are given to a content. The activity screen 40b and log screen 40a may be combined together into a single screen.

FIGS. 5A to 5D illustrate lower-level screens of a human relations network screen related to other persons according to an exemplary embodiment of the present invention.

Selection of a counterpart item 12 in a human relations network screen 10 of FIG. 5A leads to display of a lower-level screen. Like the case of the user item 11, how to select a counterpart item 12 may depend upon the input unit of the mobile terminal.

Selection of a counterpart item 12 leads to display of a log screen 60a as illustrated in FIG. 5B. The log screen 60a provides overview information on communication events between the user and a counterpart associated with the selected counterpart item 12 during a target duration. In particular, the overview information includes summary information on all communication means and on individual communication means.

The log screen 60a includes an icon 61.a for all communication means and icons 61b for individual communication means (telephone calls, messages and instant messages). A value 62a denotes the number of communication events between the selected counterpart and the user and is displayed next to the icon 61a. Values 62b denote details of communication and are displayed next to the icons 61b. The values 62b denote calling lengths for calls and amount of text data for messages and instant messages. A focus 63 or pointer (not shown) can be displayed on the log screen 60a. A screen type indicator 64 for the current screen type and a ‘Menu’ key 65 for selecting related functions are provided at the lower end of the log screen 40a. A counterpart item 66, counterpart name 67, and target duration 68 are displayed at the upper end of the log screen 60a.

Selecting one of icon 61a for all communication means and icons 61b for individual communication means using the focus 63 leads to display of a corresponding detail screen. FIG. 5C illustrates a detail screen 70 displayed in response to selection of the icon 61b for messages as a particular communication means. The detail screen 70 provides a list of messages in a chronological order. An indicator 71, for indicating if the communication was outgoing or incoming, an indicator 72, for indicating the communication means, and dates and times 73 of communication events are arranged in the detail screen 50a. The selection indicator 74 is provided at the upper end of the detail screen 70.

FIG. 5D illustrates an activity screen 60b for performing actions for communication. A screen transition between the log screen 60a (FIG. 5B) and activity screen 60b (FIG. 5D) can be made by changing the label of the screen type indicator 64 through the left soft key. In the activity screen 60b, an icon 61b and a means name 69 are given to one communication means.

In an exemplary implementation when the input unit of the mobile terminal includes a pointing device or touch screens lower-level screens (log screen and activity screen) of a counterpart item in the human relations network screen 10 can be reached using different selection manners. That is, selecting a line segment 13 in the human relations network screen 10 of FIG. 5A can lead to display of the log screen 60a of FIG. 5B, and selecting a counterpart item 12 can lead to display of the activity screen 60b of FIG. 5D. Alternatively, a line segment 13 can be used to reach the activity screen 60b, and a counterpart item 12 can be used to reach the log screen 60a.

Hereinabove, an exemplary user interface based on human relations, including a human relations network screen and lower-level screens, is described using screen representations. Next, a mobile terminal and user interface forming method are described according to an exemplary embodiment of the present invention.

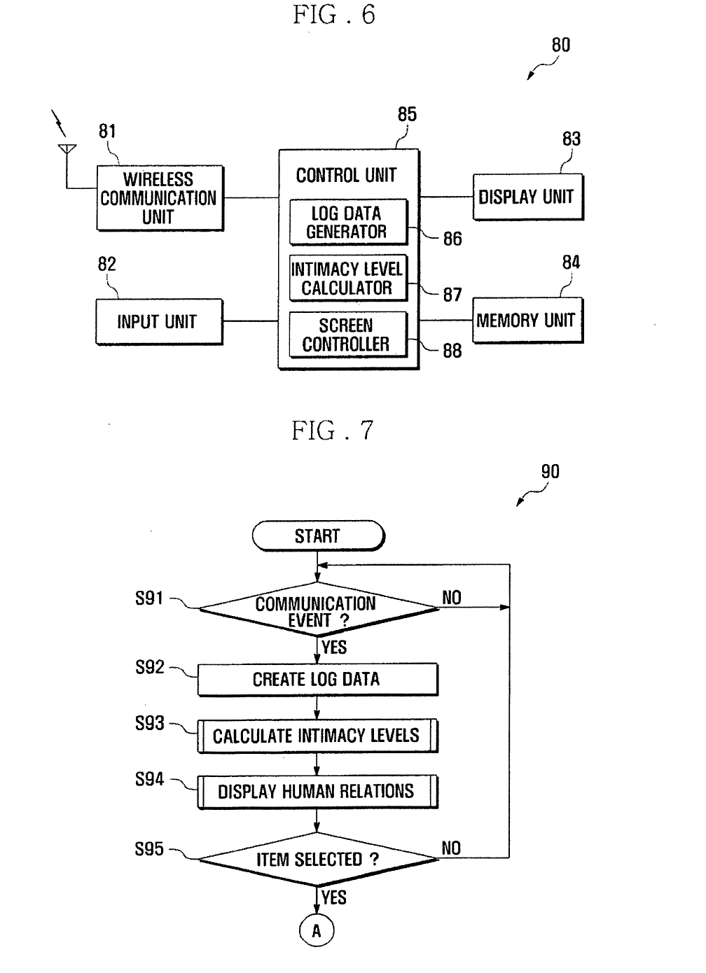

FIG. 6 is a schematic block diagram illustrating a mobile terminal 80 in accordance with an exemplary embodiment of the present invention.

Referring to FIG. 6, the mobile terminal 80 includes a wireless communication unit 81, input unit 82, display unit 83, memory unit 84 and control unit 85. The control unit 85 includes a log data generator 86, intimacy level calculator 87 and screen controller 88.

The mobile terminal 80 can be any portable electronic appliance having communication and display capabilities, such as a mobile phone, smart phone, personal digital assistant (PDA), mobile broadcast receiver including a digital multimedia broadcasting (DMB) receiver, or multimedia player including an MP3 audio player and portable multimedia player (PMP).

The wireless communication unit 81 transmits and receives a radio frequency signal to and from another mobile terminal. For example, the wireless communication unit 81 converts a message signal from the control unit 85 into a radio frequency signal through modulation and frequency conversion and transmits the radio frequency signal through an antenna. The wireless communication unit 81 extracts a message signal from a radio frequency signal received by the antenna through frequency conversion and demodulation and forwards the message signal to the control unit 85.

The input unit 82 generates an input signal corresponding to a user action and sends the generated input signal to the control unit 85. For example, the input unit 82 generates a selection signal for entering a lower-level screen from the human relations network screen. The input unit 82 may include any of any of a keypad touch pad, pointing device and touch screen.

The display unit 83 displays various information related to states and operations of the mobile terminal 80. In particular, the display unit 83 displays a human relations network screen based on log data and lower-level screens such as a log screen, activity screen and detail screen. The display unit 83 normally includes a panel of a liquid crystal display (LCD) device and may also include a different type display device.

The memory unit 84 stores various programs and associated data to operate the mobile terminal 80. The memory unit 84 includes one or more volatile and non-volatile storage devices. In particular, the memory unit 84 stores log data created in response to occurrence of communication events and levels of intimacy derived from the log data.

The control unit 85 includes a microprocessor for controlling the overall operation of the mobile terminal 80. In an exemplary implementation, the log data generator 86 of the control unit 85 creates a piece of log data in response to occurrence of a communication event and adds the created piece of log data to the existing log data stored in the memory unit 84. The intimacy level calculator 87 calculates levels of intimacy between the user and counterparts using a portion of the stored log data corresponding to a specified target duration. The screen controller 88 controls display of a human relations network screen and lower-level screens on the display unit 83 on die basis of the calculated intimacy levels.

FIG. 7 is a flowchart 90 illustrating a first part of a user interface forming method based on human relations according to an exemplary embodiment of the present invention.

Referring to FIGS. 6 and 7, the control unit 85 of the mobile terminal in operation determines whether an occurrence of a communication event is detected in step S91. A communication event corresponds to the placement or reception of a call, or the transmission or reception of a message, instant message or data.

If an occurrence of a communication event is detected, the log data generator 86 of the control unit 85 creates a piece of log data corresponding to the detected communication event and adds the created piece of log data to the existing log data stored in the memory unit 84 in step S92. The log data includes a list of communication events including placed and received calls, sent and received messages, sent and received instant messages and sent and received data. As described in connection with Table 1, the log data includes occurrence dates and times of communication events, counterparts of communication and details of communication. The details of communication can include quantitative parameters such as dialog durations and amounts of data and frequency parameters such as the number of calls, messages, instant messages and data transfers.

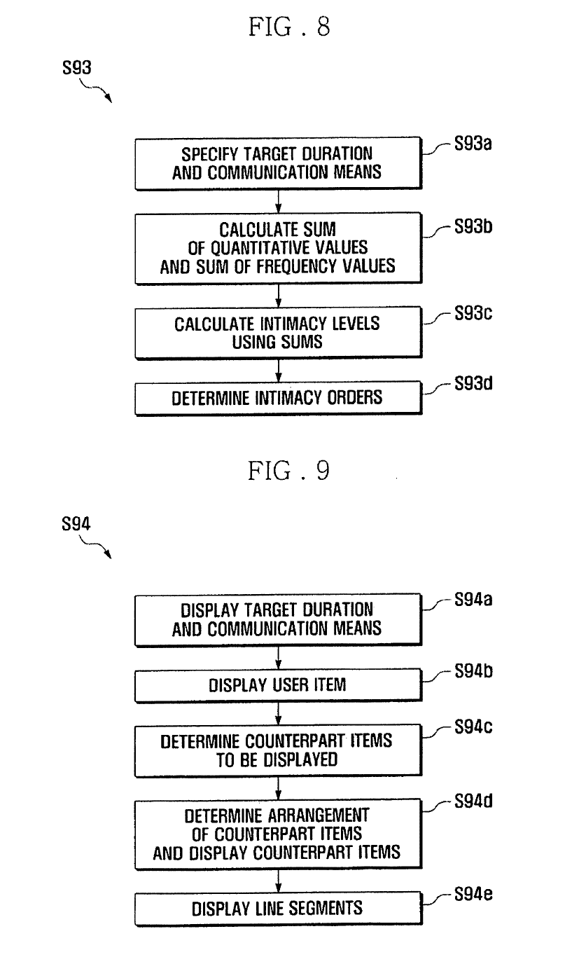

The intimacy level calculator 87 of the control unit 85 calculates levels of intimacy between the user and counterparts using a portion of the log data corresponding to a target duration in step S93. Intimacy level calculation is described in more detail with reference to FIG. 8 below.

Referring to FIG. 8, the intimacy level calculator 87 specifies a target duration and communication means to be considered for intimacy calculation in step S93a. The target duration and communication means may be set in advance or by the user.

The intimacy level calculator 87 calculates the sum of quantitative parameter values and the sum of frequency parameter values for each counterpart, related to the specified communication means, using the log data stored in the memory unit 84 in step S93b. In step S93b, only one of the sum of quantitative parameter values and the sum of frequency parameter values may be calculated. What and how to calculate is set in advance. Weights can be assigned to the individual communication means under consideration.

The intimacy level calculator 87 calculates intimacy levels of counterparts using the calculated sums in step S93c. In step S93c, lengths of line segments can be computed with reference to Table 3.

The intimacy level calculator 87 determines intimacy orders of counterparts using the calculated intimacy levels and stores the intimacy levels and intimacy orders in the memory unit 84 in step S93d.

Referring back to FIG. 7, the screen controller 88 of the control unit 85 displays human relations on the display unit 83 on the basis of the calculated intimacy levels in step S94. Display of human relations is described in greater detail below with reference to FIG. 9.

Referring to FIG. 9, the screen controller 88 displays the target duration and individual communication means under consideration on the display unit 83 as a human relations network screen in step S94a. The display format is stored in advance in the memory unit 84 or may be set by the user.

The screen controller 88 displays the user item on the human relations network screen in step S94b. A face image of the user, icon, or emotional metaphor can be used as the user item.

The screen controller 88 determines counterpart items to be displayed using the intimacy orders stored in the memory unit 84 in step S94c.

The screen controller 88 determines arrangement of the counterpart items to be displayed and displays the counterpart items on the human relations network screen in step S94d. In step S94d, locations, arrangement orders, sizes, colors and shapes of the counterpart items are determined according to intimacy levels thereof. Those counterpart items belonging to the same group in the phonebook can be arranged closely to each other.

The screen controller 88 displays line segments connecting the user item and counterpart items together on the human relations network screen in step S94e. Lengths of the line segments are in inverse proportion to the levels of intimacy between the user and the counterparts.

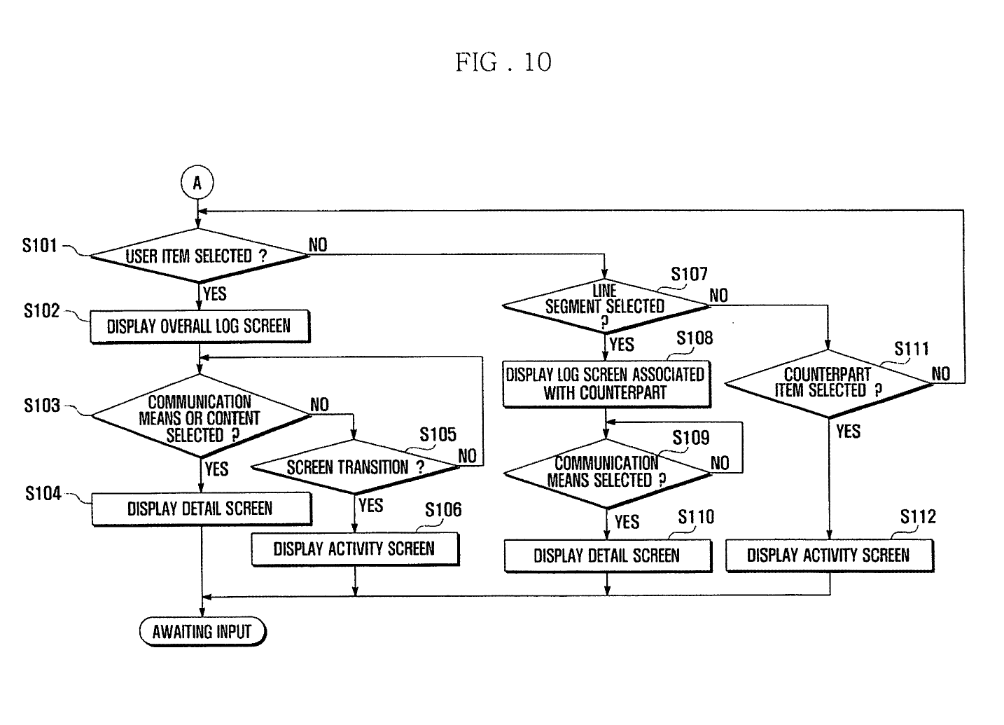

Referring back to FIG. 7, the control unit 85 determines whether a selection is made in the human relations network screen in step S95. If a selection is made, the control unit 85 performs necessary operations, which are described in connection with FIG. 10.

Referring to FIG. 10, the control unit 85 determines whether the user item is selected through the input unit 82 in step S101. If the user item is selected, the control unit 85 displays an overall log screen on the display unit 83 in step S102. The overall log screen provides summary information on the log data and contents created by the user.

If a particular communication means is selected in the overall log screen in step S103, the screen controller 88 displays a detail screen, which provides detailed information on the log data related to the selected communication means in step S104. Alternatively, if a particular content is selected in the overall log screen in step S103, the screen controller 88 displays a detail screen, which provides detailed information on the selected content in step S104.

If neither a particular communication means nor content is selected in step S103, the control unit 85 proceeds to step S105. If a screen transition request is issued in the overall log screen in step S105, the screen controller 88 displays an activity screen for performing communication in step S106. If a screen transition request is not issued in step S105, the control unit 85 returns to step S103.

If a user item is not selected in step S101, the control unit 85 determines whether a line segment is selected in step S107. If a line segment is selected, the screen controller 88 displays a log screen associated with a counterpart on the display unit 83 in step S108. The log screen provides summary information on the log data associated with a counterpart corresponding to the selected line segment.

If a particular communication means is selected in the log screen associated with a counterpart in step S109, the screen controller 88 displays a detail screen, which provides detailed information on the log data related to the selected communication means in step S110.

If a line segment is not selected in step S107, the control unit 85 determines whether a counterpart item is selected through the input unit 82 in step S111. If a counterpart item is selected, the screen controller 88 displays an activity screen for performing communication in step S112.

As is apparent from the above description, exemplary embodiments of the present invention provide a user interface forming method based on human relations for a mobile terminal. For example, there is provided a new user interface based not on functions but on human relations using log data. The user interface based on human relations enables the user to readily identify human relations and levels of communication with other persons. For example, the user can view a trend in human relations with time to identify a person whose intimacy level is high through frequent communication or to identify a person whose intimacy level is low owing to rare communication.

Communication events recorded in the log data may be arranged according to persons and communication means, thereby enabling rapid and efficient browsing of the log data. For example, selection of the user item leads to display of log data associated with all communication means, and selection of a counterpart item leads to display of log data associated with both the corresponding counterpart and specified communication means.

In addition, log data created using the user interface of the present invention can be transferred to a computer, and the log data can be continuously used for a new mobile terminal after replacement of the old mobile terminal.

Certain aspects of the present invention can also be embodied as computer readable code on a computer readable recording medium. A computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While exemplary embodiments of the present invention have been shown and described in this specification, it will be understood by those skilled in the art that various changes or modifications of the embodiments are possible without departing from the spirit and scope of the invention as defined by the appended claims and their equivalents.

What is claimed is:

1. A method of forming a user interface for a mobile terminal based on human relations, the method comprising:
creating, in response to an occurrence of a communication event between a user and at least one counterpart, a piece of log data corresponding to the communication event;
calculating at least one level of intimacy between the user and at least one counterpart for a target duration using the log data; and
displaying human relations of the user on the basis of the at least one calculated intimacy level.

2. The method of claim 1, wherein the displaying of the human relations comprises displaying a user item representing the user and at least one counterpart item representing the at least one counterpart in a human relations network screen.

3. The method of claim 2, wherein the communication event comprises at least one of an incoming call, an outgoing call, a message, an instant messages, and data.

4. The method of claim 3, further comprising adding the created piece of log data to existing log data, wherein the existing log data comprises records of at least one of placed calls, received calls, transmitted messages, received messages, transmitted instant-messages, received instant-messages, transmitted data and received data.

5. The method of claim 2, further comprising adding the created piece of log data to existing log data, wherein the existing log data comprises occurrence dates and times of communication events, counterparts of communication, and details of communication.

6. The method of claim 5, wherein the details of communication comprise information regarding at least one of an amount of communication and a frequency of communication.

7. The method of claim 6, wherein the amount of communication comprises at least one of dialog durations and amounts of data and further wherein the frequency of communication comprises at least one of the number of calls, messages, instant messages and data transfers.

8. The method of claim 6, wherein the calculating of the levels of intimacy comprises computing at least one of a sum of amounts of communication and a sum of frequencies of communication, and the combination of the sum of amounts of communication and the sum of frequencies of communication.

9. The method of claim 8, wherein the calculating of the levels of intimacy comprises assigning weights to a call, a message, an instant message and a data transfer.

10. The method of claim 2, wherein the calculating of die levels of intimacy comprises specifying a target duration and a communication means to be considered.

11. The method of claim 2, wherein the calculating of the levels of intimacy comprises determining intimacy orders of the counterparts according to the calculated intimacy levels.

12. The method of claim 11, wherein the displaying of the human relations comprises displaying a number of counterpart items associated with the highest intimacy levels on the human relations network screen.

13. The method of claim 2, wherein the displaying of the human relations comprises representing each of the user item and the at least one counterpart item using one of a face images, an icon and an emotional metaphor.

14. The method of claim 2, wherein the displaying of the human relations comprises displaying a target duration and a communication means considered.

15. The method of claim 2, wherein the displaying of the human relations comprises determining at least one of a location, an arrangement sequence, a size, a color, and a shape of the at least one counterpart item according to the calculated intimacy levels.

16. The method of claim 15, wherein the displaying of the human relations further comprises:
displaying a plurality of counterpart items; and
arranging those counterpart items belonging to a same group in proximity to each other.

17. The method of claim 2, wherein the displaying of the human relations comprises displaying at least one line segment connecting the user item and the at least one counterpart item together.

18. The method of claim 17, wherein the length of the at least one line segment is in inverse proportion to the intimacy level of the corresponding at least one counterpart item.

19. The method of claim 4, further comprising displaying, upon selection of the user item, an overall log screen providing summary information on the existing log data.

20. The method of claim 19, wherein the overall log screen further comprises summary information on contents created by the user.

21. The method of claim 4, further comprising displaying, upon selection of the at least one counterpart item, a log screen comprising summary information on a portion of the existing log data related to the selected counterpart item.

22. The method of claim 19, further comprising displaying, upon input of a screen transition request, an activity screen enabling a communication function.

23. The method of claim 17, further comprising displaying, upon selection of the at least one line segment, a log screen providing summary information on a portion of the log data related to a counterpart item connected to the selected line segment.

24. The method of claim 23, further comprising displaying, upon selection of the at least one counterpart item, an activity screen enabling a communication function.

25. The method of claim 23, further comprising displaying, upon selection of a communication means in the log screen, a detail screen providing detailed information on a portion of the log data related to the selected communication means.

26. A mobile terminal comprising:
a control unit for creating, in response to an occurrence of a communication event between a user and at least one counterpart, a piece of log data corresponding to the communication event and for calculating at least one level of intimacy between the user and the at least one counterpart for a target duration using the log data; and
a display unit for displaying human relations of the user on the basis of the at least one calculated intimacy level.
